(19) United States
(12) Patent Application Publication
(10) Pub. No.: US 2008/0068698 A1
(43) Pub. Date: Mar. 20, 2008

(54) DISPLAY UNIT AND MANUFACTURING METHOD THEREOF

(75) Inventor: Tomoyuki IRIZUMI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/838,571

(22) Filed: Aug. 14, 2007

(30) Foreign Application Priority Data
Sep. 15, 2006 (JP) 2006-250778

(51) Int. Cl. G02B 26/00; H01J 9/24

(52) U.S. Cl. 359/238; 445/24

(57) ABSTRACT

A display unit that includes a signal line provided over a substrate, a conductive film provided away from the signal line in a same layer as the signal line; a insulating base film provided over the signal line and conductive film, a polysilicon film provided over the insulating base film, an interlayer dielectric formed over the polysilicon film, a pixel electrode formed over the interlayer dielectric and a connection pattern formed away from the pixel electrode over the interlayer dielectric for connecting the polysilicon film with the signal line. A crystal grain size of the polysilicon having the conductive film formed in a lower portion is larger than a crystal grain size of the polysilicon film not having the conductive film in a lower portion.

### BACKGROUND OF THE INVENTION

1. Field of the Invention

The present invention relates to a display unit and a manufacturing method thereof.

2. Description of the Related Art

In recent years, display units such as liquid crystal displays and organic EL displays with a TFT array substrate mounted thereon having low-temperature polysilicon TFTs (Thin Film Transistor) are attracting attentions in terms of high resolution, mobility and reliability (see Tohru NISHIBE et al, “Low-Temperature poly-Si TFT-LCD”, Toshiba Review, Vol. 55 No. 2, (2000), Ikuhiro UKAI, “Low-Temperature poly-Si TFT-LCD Technology”, ED Research Co., Ltd, Apr. 20, 2005, and Shouichi MATSUMOTO, “Liquid Crystal Display Technology”, Sangyo Tosho, Nov. 8, 1996). A manufacturing method of a TFT array substrate having a conventional low-temperature polysilicon TFT is described hereinafter with reference to FIG. 6. FIG. 6 is a schematic cross-section diagram of a TFT array substrate made by the conventional manufacturing method. Note that the process described below is a process for manufacturing a top gate TFT array substrate. Firstly, a nitride base film 2, oxide base film 3 and amorphous silicon film are formed over a glass substrate 1 by plasma CVD method. Next, an annealing treatment is performed to reduce hydrogen concentration in the amorphous silicon. Then, the amorphous silicon film is crystallized by laser annealing method to be a polysilicon film. After that, the polysilicon film is patterned in a desired pattern by photolithography to form a polysilicon film 4 (mask 1).

Next, a gate insulating film 5 is formed by CVD method. Then only the position to form a retention capacity is opened and other area is covered by a resist (mask 2). P (phosphorus) is doped to the polysilicon by ion doping method. Then the resist is removed. After that, in order to control a threshold voltage of transistors, B (boron) is doped to the polysilicon film 4 through the gate insulating film 5 by ion doping method.

Then a metallic thin film for forming a gate electrode 6a is formed by sputtering. This metallic thin film is made of metal material such as Al, Cr, Mo, Ti and W or alloy material. Then a resist pattern (mask 3) is formed by photolithography. After that, the metallic thin film is patterned in a desired shape by an etchant to form the gate electrode 6a. Then the resist is removed. Next, B (boron) is doped to the polysilicon film 4 by ion doping method with the gate electrode 6a as a mask to form a P type transistor. A P type transistor is formed in this example, however to form an N type transistor, P (phosphorus) is doped to the polysilicon film 4 by ion doping method with the gate electrode 6a as a mask.

Depending on the specification of a display unit, a TFT array substrate of either N or P type channel is formed. Note that like CMOS structure, a TFT array substrate of low-temperature polysilicon having both channels of N and P type channels can be formed. To form both N and P type channels, another photolithography process is required, thereby increasing another mask.

Then, an interlayer dielectric 7 is formed by plasma CVD method. As for the interlayer dielectric 7, an oxide silicon film formed by reacting SiH₄ with N₂O or TEOS (TetraEthOxySilane, Si(OC₂H₅)₄) with O₂ can be used. Moreover, a nitride silicon film formed by reacting SiH₄ with N₂O and NH₃ can be used. Furthermore, a silicon oxynitride film formed by reacting SiH₄ with NH₃ can be used. In addition, not limited to these single layer films but may be a laminated film. To diffuse P (phosphorus) and B (boron) doped by ion doping method, a heat treatment is applied. After that, a resist pattern (mask 4) is formed by photolithography. Then after forming a contact hole 8 in the interlayer dielectric 7 by dry etching method, the resist is removed.

Next, a metallic thin film for forming a signal line 9 is formed by sputtering. As for metal material, a metal material such as Al, Cr, Mo, Ti and W or alloy material is used. Then, a resist pattern (mask 5) is formed by photolithography. After that, the metallic thin film is patterned in a desired shape by dry etching method to form the signal line 9. Next, a protection film 10 is formed by plasma CVD method. As for the protection film 10, a silicon nitride film formed by reacting SiH₄ with NH₃ can be used. Then, a heat treatment is applied to recover damage.

Next, a resist pattern (mask 6) is formed by photolithography. After forming a contact hole 8 in the protection film 10 by dry etching method, the resist is removed. Then, a transparent conductive film for forming a pixel electrode 11 is formed by sputtering. After that, a resist pattern (mask 7) is formed by photolithography. The transparent conductive film is patterned in a desired shape by dry etching method. By the abovementioned manufacturing method, a TFT array substrate having a low-temperature polysilicon TFT is completed.

A display unit having a light-shielding layer line formed over a glass substrate and a polysilicon film thereabove is disclosed in Japanese Unexamined Patent Application Publication No. 2003-297851. The document also discloses that the display unit with high display quality can be achieved by increasing crystal grain size of the polysilicon formed over the light-shielding layer line than that of polysilicon in the area not facing the light-shielding layer line.

As another method to adjust crystal grain size of the polysilicon, the configuration is disclosed in Japanese Unexamined Patent Application Publication No. 2004-207337 in which a heat storage light-shielding layer is formed below the polysilicon. Furthermore, in Japanese Unexamined Patent Application Publication No. 2001-284594, the configuration is disclosed in which a light-shielding film made of an opaque metal is included in a region facing a LDD region of a polysilicon layer over an insulating substrate. Moreover, in Japanese Unexamined Patent Application Publication No. 2005-136138, the configuration is disclosed in which a light absorption layer is included below a semiconductor thin film.

In the meantime, in the manufacturing method of a TFT array substrate, it is an extremely significant issue to improve productivity while enhancing display quality and reducing the number of manufacturing processes. However, in the manufacturing method of the TFT array substrate having one channel of low-temperature polysilicon according to the conventional technique shown in FIG. 6, for a TFT array substrate having either n or P type channel, the number of masks used in the photolithography process is 7 as described above. As for the configuration having both N and P type channels, the number of masks used in photolithography process is 8. Thus the productivity has been low. Also in Japanese Unexamined Patent Application Publications No. 2003-297851, No. 2004-207337 and No. 2001-284594, 7 masks are required in the manufacturing process of the TFT array substrate. Furthermore, in Japanese Unexamined Patent Application Publication No. 2005-136138, in the manufacturing process of the TFT array substrate, 8 masks are required.

Note that in Japanese Unexamined Patent Application Publication No. 2002-76351, a method is suggested in which both N and P type channel structure is formed by one mask. In order to manufacture a TFT array substrate having one channel structure of the transmissive liquid crystal display device, 6 masks are required.

### SUMMARY OF THE INVENTION

The present invention is made in view of above-mentioned background and provides a display unit with excellent display quality and high productivity and a manufacturing method thereof.

According to an aspect of the present invention, there is provided a display unit that includes a signal line provided over a substrate, a conductive film provided away from the signal line in a same layer as the signal line; a insulating base film provided over the signal line and conductive film, a polysilicon film provided over the insulating base film, an interlayer dielectric formed over the polysilicon film, a pixel electrode formed over the interlayer dielectric and a connection pattern formed away from the pixel electrode over the interlayer dielectric for connecting the polysilicon film with the signal line. A crystal grain size of the polysilicon having the conductive film formed in a lower portion is larger than a crystal grain size of the polysilicon film not having the conductive film in a lower portion.

The present invention provides a display unit with excellent display quality and productivity and a manufacturing method thereof.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic plan view showing the configuration of a TFT array substrate used in a display unit according to an embodiment of the present invention;

FIG. 2 is a schematic plan view showing the configuration of a pixel for the TFT array substrate;

FIG. 3 is a schematic plan view showing the configuration of a driving unit of the TFT array substrate;

FIGS. 4A to 4E are schematic cross-section diagrams showing a manufacturing method of a low-temperature polysilicon TFT array substrate;

FIG. 5 is a schematic cross-section diagram for forming a polysilicon film of the driving unit; and

FIG. 6 is a schematic cross-section diagram showing a conventional TFT array substrate.

### DESCRIPTION OF THE PREFERRED EMBODIMENTS

An embodiment the present invention is applicable is described hereinbelow. The description hereinbelow is directed for an embodiment of the present invention and the present invention is not limited to the embodiment below.

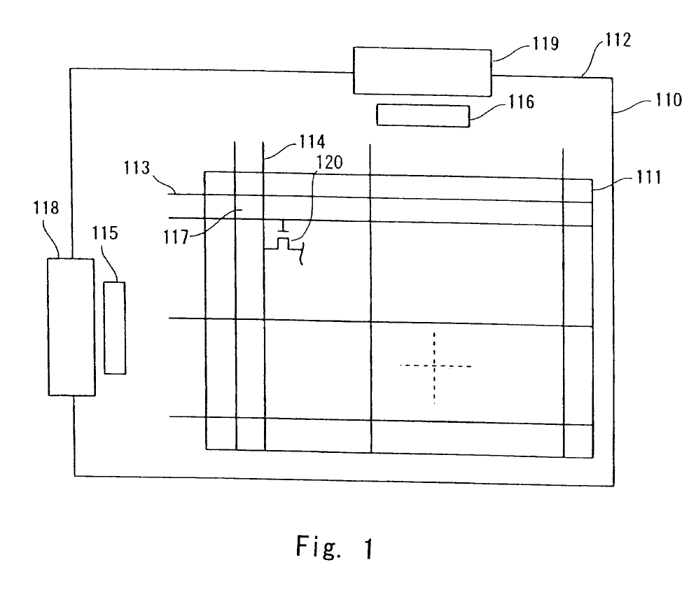

FIG. 1 is a schematic plan view showing the configuration of a TFT array substrate used in a display unit according to an embodiment of the present invention. Firstly, the embodiment below is described hereinafter in detail with reference to FIG. 1. A display unit having this TFT array substrate is a flat panel display such as a liquid crystal display and organic EL display unit. Here, the liquid crystal display which is an example of display units, is described.

The display unit according to the embodiment of the present invention includes a substrate 110. The substrate 110 is for example a TFT array substrate having TFTs 120 arranged in array. To the substrate 110, a display area 111 and a frame area 112 surrounding the display area 111 are provided. A plurality of gate lines (scan signal lines) 113 and a plurality of signal lines (display signal lines) 114 are formed in the display area 111. The plurality of gate lines 113 are provided in parallel. Likewise, the plurality of signal lines 114 are provided in parallel. The gate lines 113 and signal lines 114 are formed to cross each other. The gate lines 113 and signal lines 114 are orthogonal. Moreover, an area surrounded by adjacent gate line 113 and signal line 114 is a pixel 117. Accordingly in the substrate 110, pixels 117 are arranged in matrix.

Additionally in the frame area 112 of the substrate 110, a scan signal driving circuit unit 115 and display signal driving circuit unit 116 are provided. The gate lines 113 are extended from the display area 111 to the frame area 112. Furthermore, the gate lines 113 are connected with the scan signal driving circuit unit 115 at the end part of the substrate 110. The signal lines 114 are also extended from the display area 111 to the frame area 112. The signal lines 114 are connected with the display signal driving circuit unit 116 at the end part of the substrate 110. An external line 118 is connected near the scan signal driving circuit unit 115. Furthermore, an external line 119 is connected near the display signal driving circuit unit 116. The external lines 118 and 119 are wiring boards such as FPC (Flexible Printed Circuit).

Various signals are supplied to the scan signal driving circuit unit 115 and display signal driving circuit unit 116 via the external lines 118 and 119. The scan signal driving circuit unit 115 supplies a gate signal (scan signal) to the gate line (scan signal line) 113 according to an external control signal. By the gate signal, the gate lines 113 are selected sequentially. The display signal driving circuit unit 116 supplies a display signal to the signal lines 114 according to an external control signal or display data. This enables to supply a display voltage according to the display data to each of the pixels 117.

Inside the pixel 117, at least one TFT 120 is formed. The TFT 120 is placed near the intersection of the signal line 114 and gate line 113. For example, this TFT 120 supplies the display voltage to a pixel electrode. That is, by the gate signal from the gate line 113, the TFT 120, which is a switching device, is turned on. This enables to apply the display voltage to the pixel electrode connected to a signal line of the TFT from the signal line 114. Moreover, an electric field according to the display voltage is generated between the pixel electrode and an opposing electrode. Note that an alignment film (not shown) is formed over the surface of the substrate 110.

Furthermore, an opposing substrate (not shown) is placed facing the TFT array substrate. The opposing substrate is for example a color filter substrate and placed to the visible side. To the opposing substrate, a color filter, black matrix (BM) and an alignment film or the like are formed. In addition, a liquid crystal layer is held between the substrate 110 and opposing substrate. More specifically, liquid crystal is filled between the substrate 110 and opposing substrate. Further, a polarizing plate and retardation plate or the like are provided to the surface outside the substrate 110 and opposing substrate. Moreover, a backlight unit or the like is provided to the non-visible side of a liquid crystal display panel.

The liquid crystal is driven by the electric field between the pixel electrode and common electrode and an alignment direction of the liquid crystal between the substrates changes. This changes the polarization of the light passing through the liquid crystal layer. That is, the light that has passed the polarization plate and became a linearly polarized light changes its polarization state by the retardation plate and liquid crystal layer. More specifically, in a transparent area, the light from the backlight unit becomes a linearly polarized light by the polarization plate provided to the TFT array substrate side. Further, by the linearly polarized light passing through the retardation plate of the TFT array substrate side, liquid crystal layer, and retardation plate of the opposing substrate side, polarization state changes. On the other hand, in a reflection area, an outside light entered from the visible side of the liquid crystal display panel becomes a linearly polarized light by the polarization plate of the opposing substrate. Then by this light traveling back and forth between the retardation plate of the opposing substrate and liquid crystal layer, the polarization state changes.

Next, the amount of light passing through the polarization plate of the opposing substrate side changes according to the polarization state. More specifically, among a transmitted light transmitting from the backlight unit through the liquid crystal panel and a reflected light reflected at the liquid crystal panel, the amount of light passing through the polarization plate of the visible side changes. The alignment direction of the liquid crystal changes according to the applied display voltage. Therefore, by controlling the display voltage, the amount of light passing through the polarization plate of the visible side can be changed. That is, by changing the display voltage to each pixel, a desired image can be displayed.

To be more specific, to display black, a light is made to be a linearly polarized light having almost same vibration direction (plane of polarization) as an absorption axis of the polarizing plate of the visible side. By this, almost all the light is blocked by the polarization plate of the visible side and black can be displayed. On the other hand, to display white, a light is made to be a linearly polarized light or circularly polarized light or the like in a direction almost orthogonal to the absorption axis of the polarization plate of the visible side by the retardation plate and liquid crystal layer. By this, as the light passes through the polarization plate of the visible side, white can be displayed. As described above, the display voltage applied to each pixel can be controlled by a gate and source signals. This changes the alignment of the liquid crystal layer and the polarization state changes according to the display voltage. Thus a desired image can be displayed.

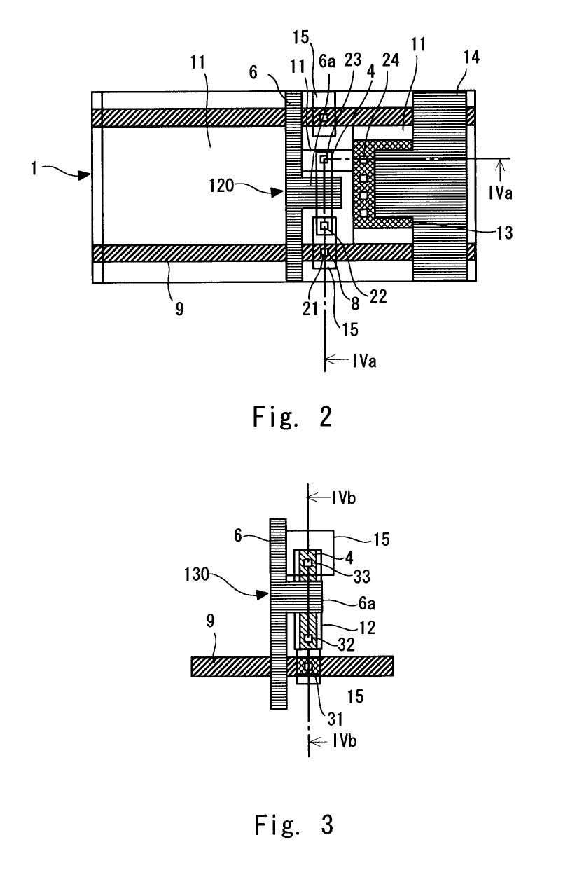

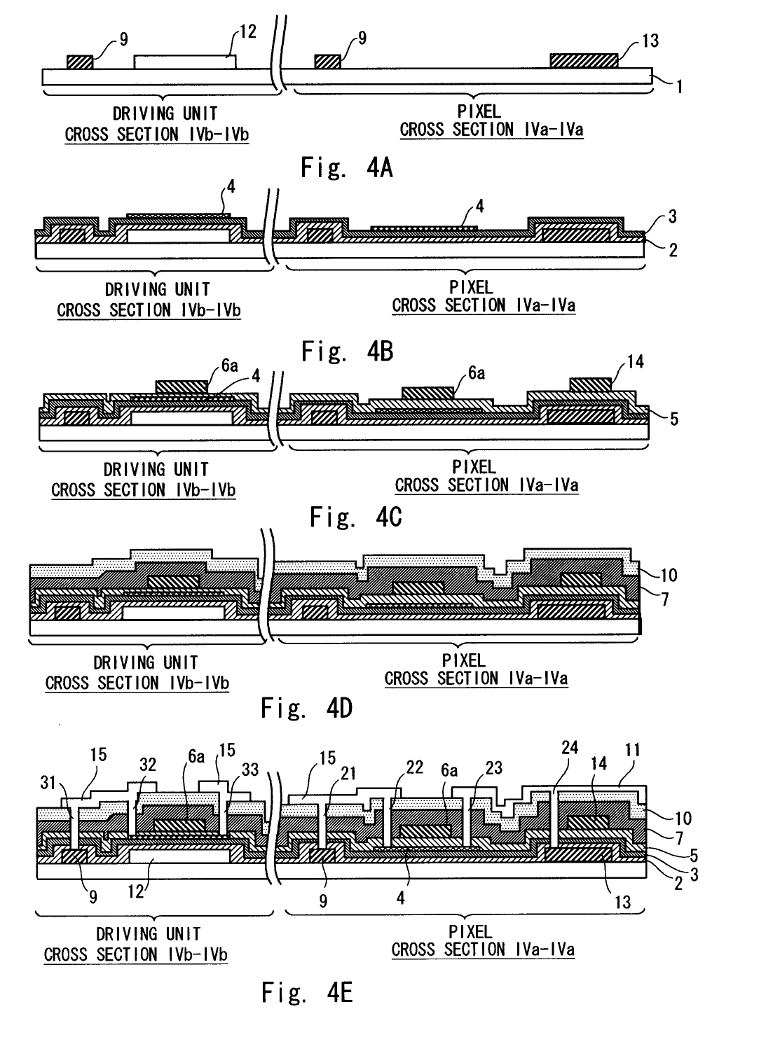

The configuration and manufacturing method of the TFT array substrate is described hereinafter in detail with reference to FIGS. 2, 3 and 4A to 4E. The TFT array substrate includes a TFT 120 provided to the pixel 117 in the display area 111 and a TFT 130 provided to the driving circuit units 115 and 116 (hereinafter collectively referred to as a driving unit). FIG. 2 is a schematic plan view showing the configuration of the pixel 117 of the TFT array substrate. FIG. 3 is a schematic plan view showing the configuration of the TFT in the driving unit of the TFT array substrate. FIGS. 4A to 4E are cross-section diagrams showing the manufacturing method of the TFT array substrate having a top gate low-temperature polysilicon TFT. In FIGS. 4A to 4E, a cross section taken along the line IVa-IVa of FIG. 2 is shown on the right side and a cross section taken along the line IVb-IVb of FIG. 3 is shown on the left side.

The configuration of the pixel 117 is described hereinafter with reference to FIGS. 2 and 4A to 4E. As shown in FIG. 2, a gate line 6 and the signal lines 9 are formed to cross each other. The gate line 6 and signal lines 9a are orthogonal. An area surrounded by the adjacent gate line 6 and signal lines 9 is to be the pixel 117 shown in FIG. 1. Accordingly, to the glass substrate 1, the pixels 117 are arranged in matrix. The gate electrode 6a is extended from the gate line 6. A retention capacity line 14 is formed over the glass substrate 1. The retention capacity line 14 is provided almost parallel to the gate line 6.

The nitride base film 2 and oxide base film 3 are provided over the signal lines 9. Accordingly the signal lines 9 and gate line 6 cross each other with the nitride base film 2 and oxide base film 3 interposed therebetween. The signal lines 9 in the pixel 117 are to be the signal lines 114 in FIG. 1, while the gate line 6 is to be the gate line 113.

The polysilicon layer 4 is formed below the gate electrode 6a (see FIG. 2). The gate insulating film 5 is placed between the gate electrode 6a and polysilicon film 4. Thus, the gate electrode 6a and polysilicon film 4 are placed facing each other with the gate insulating film 5 interposed therebetween. The polysilicon film 4 is formed running over both sides of the gate electrode 6a. For the polysilicon film 4, one of the portion running over the gate electrode 6a is to be a TFT source area, and another is to be a TFT drain area. Further, for the polysilicon film 4, the portion immediately below the gate electrode 6a is to be a channel area. Thus, the channel region is formed between the source and drain regions. The channel region is placed to face the gate electrode 6a with the gate insulating film 5 interposed therebetween.

Connection patterns 15 are formed over the source region of the polysilicon film 4 (see FIGS. 2 and 4E). The connection patterns 15 are formed over the interlayer dielectric 7 and protection film 10 that are placed over the gate line 6 and gate electrode 6a. In a position where the source region of the polysilicon film 4 faces the connection pattern 15, a contact hole 22 is formed penetrating the gate insulating film 5, interlayer dielectric film 7 and protection film 10. Furthermore, the connection pattern 15 is connected with the source region of the polysilicon film 4 via the contact hole 22.

The connection patterns 15 are extended to the signal lines 9 (see FIG. 4E). Additionally, in a position where the signal line 9 faces the connection pattern 15, a contact hole 21 is formed penetrating the nitride base film 2, oxide base film 3, gate insulating film 5, interlayer dielectric 7 and protection film 10. The signal line 9 is connected with the connection pattern 15 via the contact hole 21. By this, the signal line 9 is connected with the source region of the polysilicon film 4 via the connection pattern 15. The pixel electrode 11 is formed by the same conductive layer as the connection pattern 15. Furthermore, in a position where the pixel electrode 11 faces the silicon film 4, a contact hole 23 is formed penetrating the gate insulating film 5, interlayer dielectric 7 and protection film 10. The pixel electrode 11 is connected with the drain region of the polysilicon film 4 via the contact hole 23. Therefore, the signal line 9 is connected with pixel electrode 11 via the TFT 120 including the polysilicon film 4. Accordingly, the display voltage according to the display signal supplied to the signal line 9 is supplied to the pixel electrode 11 via the TFT 120 which is turned on by a gate signal.

The pixel electrode 11 is placed almost all over excluding the TFT 120 of the pixel 117. Thus the pixel electrode 11 is also placed over the retention capacity line 14. The interlayer dielectric 7 and protection film 10 is placed between the retention capacity line 14 and pixel electrode 11. The retention capacity electrode 13 is formed below the retention capacity line 14. The retention capacity electrode 13 is formed by the same layer as the signal line 9. Therefore, the retention capacity electrode 13 is covered by the nitride base film 2, oxide base film 3 and gate insulating film 5. The retention capacity electrode 13 is formed to shape an island in the pixel 117. The nitride base film 2, oxide base film 3 and gate insulating film 5 are placed between the retention capacity electrode 13 and retention capacity line 14. A retention capacity is formed by the retention capacity electrode 13 and retention capacity line 14 placed facing each other with the nitride base film 2 and oxide base film 3 interposed therebetween. More specifically, the retention capacity electrode 13 becomes a bottom electrode for forming the retention capacity and the retention capacity line 14 becomes a top electrode, thereby forming the retention capacity.

The retention capacity electrode 13 is formed longer in the left direction of FIG. 4E than the retention capacity line 14. That is, in the retention capacity electrode 13, a region not opposed to the retention capacity line 14 is formed. In the non-opposing region of the retention capacity electrode 13, a contact hole is formed penetrating the nitride base film 2, oxide base film 3, gate insulating film 5, interlayer dielectric 7 and protection film 10 from the surface of the protection film 10. In this example, 4 contact holes 24 are formed over the retention capacity electrode 13 (see FIG. 2). The pixel electrode 11 is connected with the retention capacity electrode 13 via the contact hole 24. Thus potentials of the pixel electrode 11 and retention capacity electrode 13 become same. This enables to retain the display voltage supplied to the pixel electrode 11.

Next, the configuration of the TFT 130 in the driving unit is described in detail with reference to FIGS. 3 and 4E. Basic configuration of the TFT 130 in the driving unit is same as the TFT 120 of the pixel 117. More specifically, the gate line 6 and signal line 9 are formed to cross each other. Moreover, the gate electrode 6a is extended from the gate line 6. The polysilicon film 4 is formed below the gate electrode 6a. The gate insulating film 5 is placed between the gate electrode 6a and polysilicon film 4. Thus the gate electrode 6a is placed to face the polysilicon film 4 with the gate insulating film 5 interposed therebetween. The polysilicon film 4 is formed larger than the gate electrode 6a in the horizontal direction of FIG. 4E. That is, for the polysilicon film 4, a region not opposed to the gate electrode 6a is formed. For the polysilicon film 4, one of the portion of the non-opposed region to the gate electrode 6a is to be a TFT source area, and another is to be a TFT drain area. Furthermore for the polysilicon film 4, the portion immediately below the gate electrode 6a is to be a channel area. Thus, the channel region is formed between the source and drain regions. A connection pattern 15 is formed over the source region of the polysilicon film 4. The connection pattern 15 is formed over the interlayer dielectric 7 and protection film 10 that are placed over the gate line 6 and gate electrode 6a. In a position where the source region of the polysilicon film 4 faces the connection pattern 15, a contact hole 32 is formed penetrating the gate insulating film 5, interlayer dielectric film 7 and protection film 10. Furthermore, the connection pattern 15 is connected with the source region of the polysilicon film 4 via the contact hole 32. Additionally, in a position where the signal line 9 faces the connection pattern 15, a contact hole 31 is formed penetrating the nitride base film 2, oxide base film 3, gate insulating film 5, interlayer dielectric 7 and protection film 10. The signal line 9 is connected with the connection pattern 15 via the contact hole 31. By this, the signal line 9 is connected with the source region of the polysilicon film 4 via the connection pattern 15.

In the TFT 130 of the driving unit, a conductive film 12 is formed below the polysilicon film 4. The conductive film 12 is formed by the same layer as the signal line 9 and retention capacity electrode 13. Accordingly, the conductive film 12, signal line 9 and retention capacity electrode 13 are formed by the same material. The conductive film 12 is placed away from the signal line 9 and retention capacity electrode 13. The nitride base film 2 and oxide base film 3 are placed between the conductive film 12 and polysilicon film 4. That is, the conductive film 12 and polysilicon film 4 are placed facing each other with the nitride base film 2 and oxide base film 3 interposed therebetween. Furthermore, the conductive film 12 is formed to shape an island, corresponding to the pattern shape of the polysilicon film 4. More specifically, the conductive film 12 is formed away from the signal line 9 and retention capacity electrode 13.

The conductive film 12 is formed below the polysilicon film 4 composing the TFT 130 of the driving unit. On the other hand, the conductive film 12 is not formed below the polysilicon film 4 composing the TFT 120 of the pixel 117. That is, in the driving unit, the conductive film 12, nitride base film 2 and oxide base film 3 are formed between the glass substrate 1 and polysilicon film 4. In the pixel 117, only the nitride base film 2 and oxide base film 3 are formed between the glass substrate 1 and polysilicon film 4. As described above, the conductive film 12 is formed only in the frame area 112 and not in the display area 111.

In a process to crystallize the polysilicon film 4 by laser annealing, the crystallization of the polysilicon film 4 is promoted by the conductive film 12 placed therebelow. Accordingly, crystal grain size of the polysilicon film 4 composing the TFT 130 is larger than that of the polysilicon film 4 composing the TFT 120. By having a larger grain size of the polysilicon film for the driving unit, favorable TFT characteristics can be obtained. At this time, grain size of the polysilicon film 4 for the pixel 117 may be smaller than the driving unit so as not to create variations in display quality. By the above configuration, a TFT array substrate with high productivity and display quality can be achieved.

The manufacturing method of the TFT array substrate is described hereinafter in detail with reference to FIGS. 4A to 4E. Firstly, a metallic thin film for forming the signal line 9, conductive film 12 and retention capacity electrode 13 is formed by sputtering over the glass substrate 1 such as a glass substrate. As for the metallic thin film, Al (aluminum), Cr (chromium), Mo (molybdenum), Ti (titanium), W (tungsten) or an alloy of these materials added with a small amount of other material can be used. In this example, a laminated structure of Al alloy/Mo alloy with thickness 300 nm/100 nm each is used. After forming the metallic thin film for forming the signal line 9, conductive film 12 and retention capacity electrode 13, a resist pattern (mask 1) is formed by photolithography. Then the metallic thin film is patterned in a desired shape by dry etching, and the signal line 9, conductive film 12 and retention capacity electrode 13 are formed. After that, the resist is removed. This creates the configuration shown in FIG. 4A. By forming the signal line 9, conductive film 12 and retention capacity electrode 13 over the glass substrate 1 in a same process, the number of processes can be reduced and thereby improving productivity.

Next, the nitride base film 2 is formed over the signal line 9, conductive film 12 and retention capacity electrode 13. The nitride base film 2 is formed by plasma CVD method. To be more specific, as for the nitride base film 2, a silicon nitride film having a thickness of 50 nm can be used. The nitride base film 2 is formed to prevent Na (sodium) contamination from the glass substrate 1. Next, the oxide base film 3 is formed. The oxide base film 3 is formed by plasma CVD method. To be more specific, as for the oxide base film 3, a silicon oxide film having a thickness of 200 nm can be used. The oxide base film 3 serves a supplementary role when crystallizing amorphous silicon, which is carried out later. For example, a crystal grain size can be adjusted by the film thickness of the oxide base film 3. Over the glass substrate 1, 2 layers of insulating films including the nitride base film 2 and oxide base film 3 is formed, however either one of the base insulating film may be formed over the glass substrate 1. Next, an amorphous silicon film for forming the polysilicon film 4 is formed. For example by plasma CVD method, an amorphous silicon film having a thickness of 70 nm is formed over the oxide base film 3. In order to suppress from attaching impurities to film interfaces of the nitride base film 2, oxide base film 3 and amorphous silicon film, they may better be formed consecutively in vacuum by plasma CVD method. Then a heat treatment is applied to reduce hydrogen concentration in the amorphous silicon.

After that, the amorphous silicon film is crystallized by laser annealing method to be the polysilicon film 4. In laser annealing method used in the embodiment of the present invention, a YAG laser with an optical wavelength of 532 nm is used and annealed with irradiation energy density 350 mJ/cm² and pulse width 70 nsec. For laser annealing method, excimer laser can be used other than the YAG laser, but it is not limited to this. A laser is irradiated with uniformed irradiation energy density to the glass substrate 1. The laser is irradiated from upper side of the glass substrate 1. More specifically, the laser is irradiated to the amorphous silicon film from the opposite surface to the oxide base film 3 of the amorphous silicon film. That is, the laser beam is irradiated to the glass substrate 1 from the side where the amorphous silicon film is exposed. In this way, the laser is irradiated from the upper portion of the amorphous silicon film directly to the amorphous silicon film. Then, a resist pattern (mask 2) is formed by photolithography and the polysilicon film 4 is patterned in a desired shape by dry etching. Next, the resist is removed. This creates the configuration shown in FIG. 4B.

While the crystal grain size of the polysilicon film 4 for the pixel 117 is 0.2 to 0.4 μm, crystal grain size of the polysilicon film for the driving unit is 0.5 to 0.9 μm. That is, the crystal grain size of the polysilicon film 4 for the driving unit is larger than that of the polysilicon film 4 for the pixel 117. This is considered to be because that in the driving unit, when the laser is irradiated to the polysilicon film from the upper portion, heat is absorbed to the conductive film 12 in the lower portion and the heat can not easily escape. The crystallization is promoted by the heat and polysilicon with large crystal grain size is formed. However, the temperature of the conductive film 12 that increases by the heat absorption must be lower than a melting point of the conductive film 12. That is, the crystallization is performed under an annealing condition not exceeding the melting point of the conductive film 12.

Grain boundary, which is a boundary between grains of the polysilicon, diffuses carrier (electron or hole) and acts as a trap when the carrier passes through the grain boundary. Therefore, when a carrier passes through the grain boundary, the more the carrier is trapped, the smaller the mobility becomes. With smaller grain size, it is easy to be trapped as the carrier frequently passes through the grain boundary. In other words, the larger the crystal grain size of the polysilicon, the higher the mobility and the better the TFT characteristics. By this, the crystal grain size of the polysilicon used for the TFT in the driving unit is better to be larger. On the other hand, for the polysilicon of the TFT in the pixel unit, the crystal grain size must be configured smaller than the crystal grain size of the polysilicon in the driving unit. This is because that in the pixel unit, the variation in the TFT characteristics caused by the variation in the grain boundary of the polysilicon greatly influences the display quality.

Next, the gate insulating film 5 is formed over the polysilicon film 4 to cover the polysilicon film 4. For example, the gate insulating film 5 is formed by plasma CVD method. More specifically, a silicon oxide film having a thickness of 80 nm can be used as the gate insulating film 5. Next, in order to control a threshold voltage of transistors, B (boron) is doped to the polysilicon film 4 through the gate insulating film 5 by ion doping method. A metallic thin film for forming the gate line 6 and gate electrode 6a is formed by sputtering. As for the metallic thin film, Al (aluminum), Cr (chromium), Mo (molybdenum), Ti (titanium), W (tungsten) or an alloy of these materials added with a small amount of other material can be used. In this example, a Mo alloy having a thickness of 300 nm is used. After forming the metallic thin film for forming the gate line 6, gate electrode 6a and retention capacity line 14, a resist pattern (mask 3) is formed by photolithography. The metallic thin film is patterned in a desired shape by an etchant and then the resist is removed. By this, the gate line 6, gate electrode 6a and retention capacity line 14 shown in FIG. 4C are formed. After that, B (boron) is doped to the polysilicon film 4 through the gate insulating film 5 by ion doping method. A P type transistor is formed by this.

Although a P type transistor is formed in this example, an N type transistor can be used by doping P (phosphorus) to the polysilicon film 4 through the gate insulating film 5 with the gate electrode 6a as a mask.

Next, the gate line 6, interlayer dielectric 7 is formed over the gate electrode 6a and retention capacity line 14. The interlayer dielectric 7 is formed to cover the gate line 6, gate electrode 6a and retention capacity line 14. For example, a silicon oxide film to be the interlayer dielectric 7 is formed by plasma CVD method. The interlayer dielectric 7 is formed by the silicon oxide film having a thickness of 500 nm and reacting TEOS (TetraEthOxySilane, Si(OC₂H₅)₄) with O₂. Then, to diffuse the P (phosphorus) and B (boron) doped by ion doping method, a heat treatment is applied. In this case, a heat treatment of 400 degree Celsius is applied for one hour in nitrogen atmosphere. After that, a silicon nitride film to be the protection film 10 is formed with a thickness of 300 nm. This creates the configuration shown in FIG. 4D. In this example, 2 layers of insulating films are formed over the gate line 6, gate electrode 6a and retention capacity line 14, however it may be a single layer. Furthermore, other than an inorganic insulating film as the interlayer dielectric 7 and protection film 10, an organic insulating film can be used.

After forming the protection film 10, the contact holes 21, 22, 23, 24, 31, 32 and 33 are formed. The contact hole 21 penetrates the protection film 10, interlayer dielectric 7, gate insulating film 5, oxide base film 3 and nitride base film 2 and reaches the signal line 9. The contact holes 22 and 23 penetrate the protection film 10, interlayer dielectric 7 and gate insulating film 5 and reaches the polysilicon film 4. The contact hole 24 penetrates the protection film 10, interlayer dielectric 7, gate insulating film 5, oxide base film 3 and nitride base film 2 and reaches the retention capacity electrode 13. Moreover, the contact hole 31 penetrates the protection film 10, interlayer dielectric 7, gate insulating film 5, oxide base film 3 and nitride base film 2 and reaches the signal line 9. The contact holes 32 and 33 penetrate the protection film 10, interlayer dielectric 7 and gate insulating film 5 and reaches the polysilicon film 4.

More specifically, a resist pattern (mask 4) is formed over the protection film 10 by photolithography. Then, the protection film 10, interlayer dielectric 7, gate insulating film 5, oxide base film 3 and nitride base film 2 are dry etched in order. By this, the contact holes 21, 22, 23, 24, 31, 32 and 33 are formed. After that, the resist is removed. Here, the contact holes 21, 22, 23 and 24 are formed to the TFT 120 in the pixel 117. Furthermore, the contact hole 21 is formed over the signal line 9. The contact holes 22 and 23 are formed over the polysilicon film. The contact hole 24 is formed over the retention capacity electrode 13. Moreover, the contact holes 31, 32 and 33 are formed to the TFT 130 in the driving unit. The contact hole 31 is formed over the signal line 9. The contact holes 32 and 33 are formed over the polysilicon film 4.

After forming the contact holes 21, 22, 23, 24, 31, 32 and 33, a transparent conductive film for forming the pixel electrode 11 and connection pattern 15 is formed over the protection film 10. The transparent conductive film is formed by sputtering. Furthermore, the transparent conductive film is also formed over the contact holes 21, 22, 23, 24, 31, 32 and 33. As for the transparent conductive film, ITO, ITZO and IZO or the like can be used. In this example, the thickness of the transparent conductive film is 80 nm. Then a resist pattern (mask 5) is formed by photolithography. The transparent conductive film is patterned in a desired shape by dry etching method to form the pixel electrode 11 and connection pattern 15. As described above, the pixel electrode 11 and connection pattern 15 are formed in a same process. Thus the pixel electrode 11 and connection pattern 15 are formed by the same material. Next, a heat treatment is applied to recover damage. The heat treatment is applied in the atmosphere at 250 degree Celsius for one hour. This creates the configuration shown in FIG. 4E.

The pixel electrode 11 is formed over the protection film 10 and also buried in the contact holes 23 and 24. The polysilicon film 4 and retention capacity electrode 13 are electrically connected via the pixel electrode 11 that is buried in the contact holes 23 and 24. Further, the connection pattern 15 inside the pixel 117 is formed over the protection film 10 and also buried in the contact holes 21 and 22. The signal line 9 and polysilicon film 4 are electrically connected via the connection pattern 15 that is buried in the contact holes 21 and 22. Moreover, the connection pattern 15 of the driving unit is formed over the protection film 10 and also buried in the contact holes 31 and 32. The signal line 9 and polysilicon film 4 are electrically connected via the connection pattern 15 that is buried in the contact holes 31 and 32. Furthermore, the connection pattern 15 that is connected with the polysilicon film 4 via the contact hole 33 is connected with another line or electrode in the driving unit.

The TFT array substrate used in the display unit according to the embodiment of the present invention is completed in this way. By the above manufacturing method, as the signal line 9, conductive thin film 12 and retention capacity electrode 13 are formed in the same layer, the masking process can be reduced. When manufacturing a TFT array substrate having one channel structure of either N or P type by the above manufacturing method, the number of masks used in the photolithography process is 5. In the manufacturing method according to the conventional technique shown in FIG. 6, 7 masks are required. Thus the present invention enables to reduce 2 masks. However, to manufacture a TFT array substrate having both N and P channels, the number of masks used in the photolithography process is 6. For example, P and N channels are formed in the driving unit to be a CMOS structure. Additionally, two or more TFTs may be formed in the pixel 117.

With the manufacturing method of the TFT array substrate used in the display unit according to the embodiment of the present invention, the number of masks used in the photolithography process can be reduced. Therefore, the manufacturing process can be shortened and processing cost can be reduced. As a result, a TFT array substrate with excellent productivity can be achieved. Furthermore, without increasing the manufacturing process of the TFT array substrate, the crystal grain size of the polysilicon can be adjusted in the same process. The crystal grain size of the polysilicon is determined according to the usage of the TFT and necessary performance. Needless to say that the crystal grain size of the polysilicon film 4 used other than the TFT may be changed. With larger crystal grain size of the polysilicon, characteristics of the TFT is improved and a TFT array substrate with higher resolution, higher mobility and better display quality can be achieved. Specially, with improved TFT characteristics of the driving unit, the TFT 130 in the driving unit can be reduced, thereby reducing the area of the driving unit in the peripheral of the pixel unit. Consequently, the area of the frame region 112 can be reduced. Thus the productivity can be improved.

The TFT array substrate formed as above is bonded with the opposing substrate having an opposing electrode and liquid crystal is filled therebetween. A sheet light source apparatus, which is a backlight unit is mounted to the backside to manufacture a liquid crystal display. Furthermore, this embodiment is not limited to liquid crystal displays but may be incorporated to display units such as an organic EL display and various electronics equipments in general. The present invention is not limited to the abovementioned embodiment but it may be modified and changed without departing from the scope and spirit of the invention.

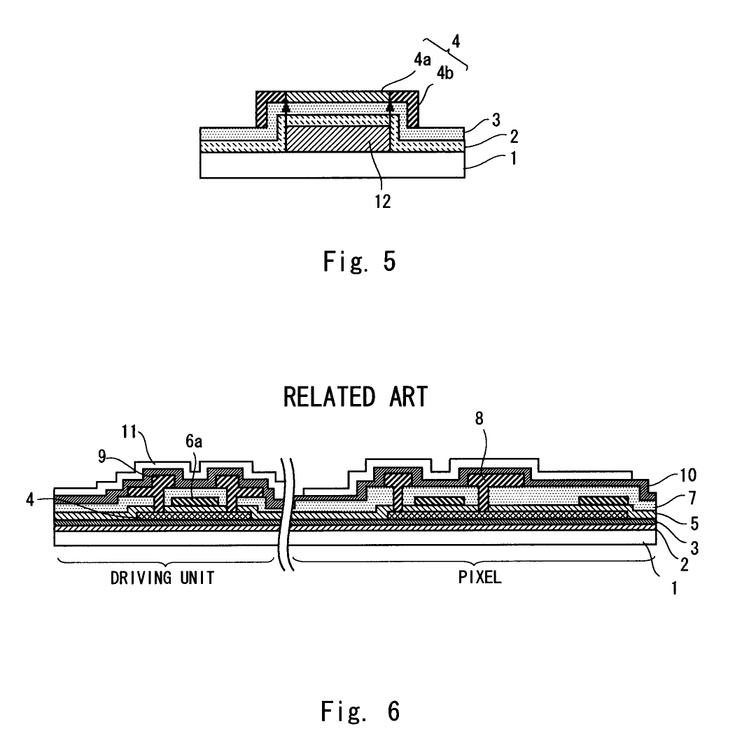

A preferred configuration of the polysilicon film 4 and conductive film 12 in the driving unit is described hereinafter. FIG. 5 is a schematic cross-section diagram when forming the polysilicon film for the driving unit. As shown in FIG. 5, the polysilicon film 4 for the driving unit is patterned longer in the horizontal direction of FIG. 5 than the conductive film 12. That is, there is a non-opposing region in the edge portion of the polysilicon film 4 that does not face the conductive film 12. In this case, the crystal grain size of the polysilicon film 4b, which is the non-opposing region in the edge portion of the polysilicon film 4, is smaller than the crystal grain size of the polysilicon film 4a that is positioned to face the conductive film 12. This is because that the laser irradiated from upper portion cannot reach enough to the bottom side of the polysilicon 4b due to shadow by the film thickness (height) of the conductive film 12. Accordingly, the crystallization at a laser annealing is blocked and not crystallized enough.

In the configuration shown in FIG. 5, the crystal grain size of the polysilicon film 4b is often smaller than 0.1 μm. As described above, by patterning the polysilicon film to form the TFT, the polysilicon film 4a having a large grain size and the polysilicon film 4b having an extremely small grain size are formed being connected in series. As described above, rather than mixing the polysilicon films with different grain sizes, the characteristics can further be improved with uniformed grain size.

Therefore, the polysilicon film 4 for the driving unit including the conductive film 12 in the lower portion is preferably has a pattern matched with the conductive film 12 with almost same width. Specifically, in the driving unit, the conductive film 12 and polysilicon film 4 are preferably formed in the same pattern shape. Alternatively, the polysilicon film 4 may be formed to fit in the region of the polysilicon film 4a shown in FIG. 5 so as not to create the non-opposing region to the conductive film 12. That is, all the region of the polysilicon film may be formed to face the conductive film 12. By configuration as above, further favorable TFT characteristics can be achieved.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A display unit comprising:
a signal line provided over a substrate;
a conductive film provided away from the signal line in a same layer as the signal line;
a insulating base film provided over the signal line and conductive film;
a polysilicon film provided over the insulating base film;
an interlayer dielectric formed over the polysilicon film;
a pixel electrode formed over the interlayer dielectric; and
a connection pattern formed away from the pixel electrode over the interlayer dielectric for connecting the polysilicon film with the signal line,
wherein a crystal grain size of the polysilicon having the conductive film formed in a lower portion is larger than a crystal grain size of the polysilicon film not having the conductive film in a lower portion.

2. The display unit according to claim 1, wherein the signal line, conductive film and the retention capacity electrode are included in a same layer over the substrate.

3. The display unit according to claim 1, wherein the polysilicon film having the conductive film in the lower portion is provided to a driving circuit unit outside a display region and the polysilicon film not having the conductive film in the lower portion is provided to a pixel inside the display region.

4. The display unit according to claim 2, wherein the polysilicon film having the conductive film in the lower portion is provided to a driving circuit unit outside a display region and the polysilicon film not having the conductive film in the lower portion is provided to a pixel inside the display region.

5. The display unit according to claim 1, wherein the polysilicon film having the conductive film in the lower portion is provided with almost same width as the conductive film.

6. The display unit according to claim 2, wherein the polysilicon film having the conductive film in the lower portion is provided with almost same width as the conductive film.

7. The display unit according to claim 3, wherein the polysilicon film having the conductive film in the lower portion is provided with almost same width as the conductive film.

8. The display unit according to claim 4, wherein the polysilicon film having the conductive film in the lower portion is provided with almost same width as the conductive film.

9. A method of manufacturing a display unit comprising:
forming a signal line and a conductive film at the same time over a substrate;
forming an insulating base film over the signal line and conductive film;
forming an amorphous silicon film over the insulating base film;
heating the amorphous silicon film to form a polysilicon film;
forming a gate insulating film over the polysilicon film;
forming a gate electrode placed facing a channel region of the polysilicon over the gate insulating film;
forming an interlayer dielectric over the gate electrode; and
forming a connection pattern for electrically connecting with the signal line and the polysilicon film and a pixel electrode over the interlayer dielectric,
wherein a crystal grain size of the polysilicon film having the conductive film formed in a lower portion is larger than a crystal grain size of the polysilicon film not having the conductive film in a lower portion.

10. The method according to claim 9, further comprising:
forming the signal line, the conductive film and a retention capacity electrode at the same time over the substrate.

11. The method according to claim 9, wherein a laser annealing method using a YAG laser with an optical wavelength of 532 nm in the formation of the polysilicon.

12. The method according to claim 10, wherein a laser annealing method using a YAG laser with an optical wavelength of 532 nm in the formation of the polysilicon.

13. The method according to claim 9, wherein the polysilicon film having the conductive film in the lower portion is provided in a driving circuit unit outside a display region and the polysilicon film not having the conductive film in the lower portion is provided inside the display region.

14. The method according to claim 10, wherein the polysilicon film having the conductive film in the lower portion is provided in a driving circuit unit outside a display region and the polysilicon film not having the conductive film in the lower portion is provided inside the display region.

15. The method according to claim 11, wherein the polysilicon film having the conductive film in the lower portion is provided in a driving circuit unit outside a display region and the polysilicon film not having the conductive film in the lower portion is provided inside the display region.

16. The method according to claim 12, wherein the polysilicon film having the conductive film in the lower portion is provided in a driving circuit unit outside a display region and the polysilicon film not having the conductive film in the lower portion is provided inside the display region.
